(19) United States
(12) Patent Application Publication
(10) Pub. No.: US 2009/0098519 A1
(43) Pub. Date: Apr. 16, 2009

(54) Device and method for employment of video games to provide physical and occupational therapy and measuring and monitoring motor movements and cognitive stimulation and rehabilitation

(76) Inventor: Jennifer Byerly, Lubbock, TX (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/287,522

(22) Filed: Oct. 10, 2008

Related U.S. Application Data
(60) Provisional application No. 60/998,303, filed on Oct. 10, 2007.

(51) Int. Cl. G09B 19/00

(52) U.S. Cl. 434/247; 463/7

(57) ABSTRACT

A device and method for providing physical, occupational, or cognitive therapy to patients which employs video game software manipulated by a game controller and running on a central processing unit such as a computer or video game console. The device and method take advantage of the wide familiarity of patients with the manipulation of game controllers to operate widely sold and popular video games to provide immediate familiarity with the system operation. An interface and software are employed along with body engageable movement tracking components to change the required controller manipulations by the user in the game, to elicit movements predetermined to provide the therapy for the user.

This application claims the benefit of U.S. Provisional Application No. 60/998,303 filed on Oct. 10, 2007 and incorporated herein in its entirety by reference. The device and method relate to patient rehabilitation after severe trauma. More particularly, it relates to the employment of video games to provide rehabilitative treatments such as physical therapy and gross motor movement, occupational therapy and fine motor movement, and cognitive skills therapies such as speech-language pathology to patients who have suffered traumatic physical injury, stroke, or head trauma. Using computer devices such as PC's or game consoles and a network, the device and method further provide a means to continually track and measure patient rehabilitation progress based on the patients' input to the various physical and mental video type games.

### 1. FIELD OF THE INVENTION

### Background of the Invention

In the United States, due to overall improved medical care, patients suffering severe trauma who might have died in past years, now survive. However, subsequent to surviving the injury, such patients are frequently physically, and on many occasions, cognitively impaired.

Conventional treatment for patients surviving severe physical and/or cognitive trauma involves participation in activities that are generally repetitive, grueling, and uninspiring. With patients already depressed or having trouble living their normal lives, such a regimen of rehabilitation and tedious treatment sessions can be hard to follow in a timely fashion.

Generally, such physical, occupational, and cognitive therapy sessions are guided by a licensed, skilled therapist who must lead and inspire the patient to participate in a tedious and sometimes boring set of tasks. In between such sessions, the patient may find it a daunting or impossible task to complete the assigned therapeutic activities on their own or with the assistance of a caregiver and without the professional therapist present. Additionally, because of the shortage of trained professionals, it can be a long stretch of time between professionally supervised sessions or a long wait to gain access to a program with such sessions. Still further, the cost can be very high for such sessions when skilled professionals must be involved at every level and session.

As such, there exists an unmet need for a system which would provide an avenue for pediatric, adolescent, and adult patients to contribute to their overall rehabilitation and increase the positive results between professionally supervised sessions, by allowing the patient to partake in their own recovery sessions using a therapeutic video game, or other computerized video displayed interactive programming adapted to the task that preferably becomes enjoyable and an activity of their choice.

Such a game or video related exercise and treatment system can be designed from the ground up as a new system adapted specifically to direct the patient through physical and mental exercises required for their rehabilitation. Or, in a particularly preferred mode of the device and method, existing well known and popular video games (such as “Halo”) can be modified by implementing one or a plurality of different therapeutic interfaces to the game. In either mode, physical, occupational and/or cognitive exercises can be designed into the game to allow performance thereof by the user to actually play the game toward a victory.

Other possibilities would include new video games or altering existing popularly played video games with an interface and adapted software with a mode of play yielding training interfaces for coaching movement strategy {e.g., a system that monitors and reacts to achievement of athletic training targets} or training interfaces for refining movement and muscle memory {e.g., a system that analyzes patterns of effective movement for dance or athleticism and trains optimal precision of muscular manipulation}.

With respect to the above description, before explaining at least one preferred embodiment of the method and apparatus herein in detail, it is to be understood that the invention is not limited in its application to the details of construction and to the arrangement of the components or steps set forth in the following description or illustrated in the drawings, nor just to physical and cognitive therapy for patients. The various apparatus and methods of employment of the invention are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception, upon which this disclosure is based may readily be utilized as a basis for designing of other devices, methods and systems for carrying out the several purposes of the present disclosed device to provide enjoyable, game-oriented and directed rehabilitation sessions to patients for physical or cognitive or other required recovery therapies. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The device herein described and disclosed provides a novel and unique method and apparatus for patient physical, occupational, and cognitive rehabilitation using biofeedback based on body-mounted or clothing-mounted sensors and instruments worn by the user. The patient's progress can be tracked and the game or program can be continually customized for both maximum enjoyment and increased or therapeutic progress in their rehabilitation. The disclosed device and method can also provide athletic training and feedback on progress thereof for athletes or persons on exercise regimens using similar biofeedback capable garments or other body-mounted movement sensors worn during playing of a video game.

As noted, the video game can be created as a new game to provide a game type environment for patient physical, occupational, and cognitive therapy that may be employed in the presence of a medical treating professional and in-between sessions with the professional. Or, in a particularly preferred mode, well-known video games such as Halo would be adapted with routines and “levels” adapting the required input on the game controls to yield the type of movement required for the patient rehabilitation. Further, the cognitive input can also be adapted to treat cognitive impairment caused by head injury or stroke.

The user would be equipped with biofeedback garments such as gloves that measure movement of hand parts, arm bands and sleeves that measure arm and joint movements, leg and torso garments having biofeedback elements to measure movement and flexion and speed and other desirable measurable qualities.

The biofeedback garments would communicate to the game or to a separate computer, with either having software adapted to measure and track progress based on the biofeedback input. The progress can be reported to medical professionals over a network, and thereafter the game levels, intensity, situational playing, and other factors can be adjusted according to patient progress and need to provide arm, hand, back, torso, leg, or other movements and repetitions to continually adapt the game to the patient's progress in the rehabilitation regimen.

It is envisioned that conventional game consoles such as the Sony PS2 or Nintendo or Microsoft game consoles would be employed. However, a personal computer adapted to the task, or a caregiver or professional provider might also have a computer system customized to the task. Software would be added to include the desired movements, regimens, repetitions, and other factors for rehabilitation of each individual patient, to existing games. Or, custom games would be written and provided to the patient for use in such game consoles.

Feedback garments can be manufactured to measure movement, flexion, speed, dexterity, and other factors that the medical professional feels are necessary. Such biofeedback garments exist already in the form of gloves and sleeves having sensors which can ascertain movement, bending, acceleration, and other factors so those skilled in the art will have no problem customizing such garments to the task at hand. Additionally, it is anticipated that other body movement sensing technology may be adapted to the task such as employing one or a plurality of cameras to watch and track patient movements based on body mounted tracking components which would allow the tracking of body movements in three dimensions.

As can be ascertained by those skilled in the art, once they have read this disclosure, the possibilities for physical and occupational training and therapy and cognitive training and rehabilitation are broad in either mode of the device. When such interfaces are provided for inclusion with known and popular games, patients who have a knowledge of game play will immediately benefit from the new routines in that there is no learning curve and they know the game already. Adding software routines for new levels or movements and the new routines will appear to the patient just like another “level” of the game toward the ultimate goal of winning the game, even when the routines are employed. The routines for treatment and exercise and biomechanical workouts can also be newly written games or video presented exercises which, for patients not familiar with this mode of entertainment, will preferably employ a goal oriented (winning the game) type of play. In either fashion, providing such an enjoyable mode of treatment will yield results far superior to conventional, repetitious, boring regimens and at lower ultimate cost.

In the case of patients who have lost an ability to manipulate their body to perform a task related to a certain tool or instrument, the method herein can be adapted to use that very tool or instrument as a component of play. For instance, if the patient is a guitar player who has lost the ability to depress the strings, the software using biomechanical movement observation and analysis components and software, may have the patient play the guitar. The play and movement of the fingers in following a video presentation would cause the video game or presentation to move forward toward the goal of the game. Thus, the patient moving their fingers on the guitar would advance along the presented game or video during their treatment.

Further, hardware interfacing with the software in the game can also ascertain patient progress through measurements of the patient's use and success in the game routines. Employing user-worn clothing such as a glove or arm band or body suit or other biofeedback measuring devices on the user's person, repetitions and progress toward the actual rehabilitative goal can be measured and input into the game through wireless or wired communication. The progress would be measured over time and can be communicated over a network to a remote doctor or therapist's office for monitoring and review. Should a patient need a slower pace or easier exercises and routines, the software can be adjusted over the network by the professional in charge of the case. Conversely, should the patient exceed expectations, or should the tracking of patient results show poor results in one or a plurality of areas of rehabilitation, customized routines or levels of the game could be uploaded to provide for each individual patients recovery regimen.

The device will feature software adapted to interface between a control which manipulates a curser in a game or in the goal oriented software. Or where use of a device, tool, or instrument is being retrained, the software would interface between observed and tracked user manipulation of that component, to play the game presented on the video screen. A means to track and communicate patient movement of limbs, fingers, arms, or body portions being retrained or used in the exercise to repair cognitive problems is employed. As noted finger, arm, hand, or other body movement is tracked by a means to observe movements such as a camera viewing specific marked positions on clothing worn by the user, or RFID chips which would broadcast movement, or RF signals from small transmitters, or other means to track and observe biomechanical movement by the patient during an exercise.

The motion sensors placed on the patient's body, such as on a glove, armband, or on clothing, would first be calibrated for a baseline of the patients abilities to move and manipulate the control while viewing the video presented on the screen. This calibration would best be done on a configuration screen of the video display which will provide anatomical images of the human body which can be selected by the user, so sensors can be mapped to specific body parts and positions. A baseline can then be obtained from movements of the tracked body sensors.

Once the baseline is ascertained, software for the system will continuously track improvement in those movements be it speed, flexibility, or reaction time to instructions or curser movement so as to measure improvement. Tracking also allows the program generating the video on the screen to adjust the video to coerce certain movements from the patient over time that will help rehabilitate their motor skills or cognitive skills based on accepted norms for such movements.

The interface may be a separate microprocessor controlled unit in operative communication with cameras or RF tracking or other means to track the patient movements and engaged to the computer or game component using IR, Wifi, USB, or other means to operatively connect the devices. Or, the interface may just be a separate component having onboard software adapted to engage at computer or game console, and change its performance and video presentation to run the rehabilitation program or software stored onboard.

For example, in the configuration mode, the user or patient, with or without a medical professional present, will be presented on the video display from the game or computer with a configuration screen. This screen will provide anatomical images of the human body for reference and which can then be selected by the patient so sensors can be mapped to specific body parts. Each sensor that is used for a patient user, can be adjusted through the configuration screen for sensitivity to game action ratios.

An example of this sensor mapping would go as follows:

Attach a sensor such as a glove, arm band, or body suit, to the desired area of the patients body. Once so attached, engage it with the microprocessor being used, using a cable or engagement means such as a USB port.

Once communication is achieved form the body-engaged sensor or sensors, software will map the sensors to an area of the body through the anatomical image in the configuration screen. If desired, notes may be attached or stored for later reference

In the process, the software with our without user input, will designate what type of sensors are being used and store that information for interfacing with software. Then the device will determine the individual patient's input range from sensor movement which may be displayed in a graphic on the screen such as a progress bar. Next, the device using software adapted to the task or preprogrammed by a professional, will set the range of action for the patient to perform.

Once the sensor or sensors are ascertained, patient input range is determined, and the desired range of action for the patient treatment is determined, the sensor or sensors involved in the control will be mapped to operate a game function such as fire, move up, move down, etc.

This interface driver will be customizable for each patient to which it will interface with a game or computer video and could be given to the patient while at the doctor, or downloaded over a network on a computer.

When employed with a wide area network connection such as an Internet connection, the patient profile can be stored on a remote server. Thereafter the interface can be automatically updated, and patient progress and performance determined by sensor movements or cognitive improvements shown by game play or manipulation, can be transmitted to the remote server. Subsequent to each session of play for treatment the patient process can be ascertained and the interface program adjusted to have the patient perform exercises based on game play which is adjusted to provide more or less of certain movements or new movements to move the therapy forward.

Thus, patients may be monitored remotely for progress and their regimen provided by the game play or computer video manipulation can also be adjusted to adapt the play to yield a customized treatment based on patient improvement or condition at the time.

Accordingly, it is an object of the invention to provide a physical and/or cognitive therapy regimen to patients, by employing existing video games using altered storylines and situations, to yield the desired movement and repetition from the patient.

Another object of this invention is to provide such a game based regimen for therapy which also employs body mounted sensors on garments or other user-worn biofeedback equipment to track and report patient progress.

A further object of this invention is to provide customized updates of the video game or other routine being employed, based on the reported tracked progress of the patient, to further customize the game to treat patient deficiencies or increase the speed of the therapy regimen.

Still another object of this invention is to provide such a video game based method and apparatus for physical therapy, occupational therapy, sports science, etc. which can also be employed for athletic training to develop muscle memory and customize athletic workouts to the athlete's individual need.

These together with other objects and advantages which become subsequently apparent reside in the details of the construction and operation as more fully hereinafter described and claimed, reference being had to the accompanying drawings forming a part thereof, wherein like numerals refer to like parts throughout.

### BRIEF DESCRIPTION OF THE DRAWING FIGURES

In the drawing figures, which are not to scale and which are merely illustrative and wherein like reference characters denote similar elements throughout the several views:

FIG. 1 depicts the movement sensors engaged to the body of a patient prior to employment of the game control.

FIG. 2 shows some types of motion tracking sensors employable with the device and method herein.

FIG. 3 depicts motion tracking sensors that are engageable with straps or directly on the body of the user.

FIG. 3a graphically depicts the typical interconnection of the interface with a computer or video game console.

FIG. 4 is a chart of tasks which may be tracked in three axes by monitoring body engaged sensors along with levels of difficulty which may be ascertained and anatomical correlations.

FIG. 5 shows a typical professionally directed physical therapy regimens for patients which may be tracked by the device and method herein to ascertain neurological progress.

FIG. 6 is a chart for a professionally directed patient implemented therapy regimen using the disclosed device and method.

FIG. 7 depicts a chart of functional movements which may be tracked by the body engaged sensors and muscles involved and role in occupational performance.

### DETAILED DESCRIPTION OF THE PREFERRED EMBODIMENTS

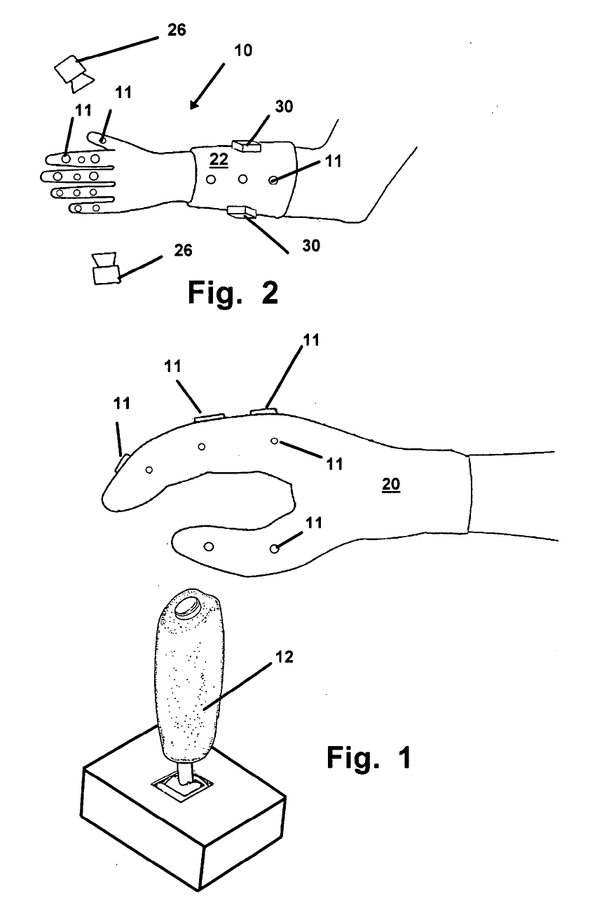

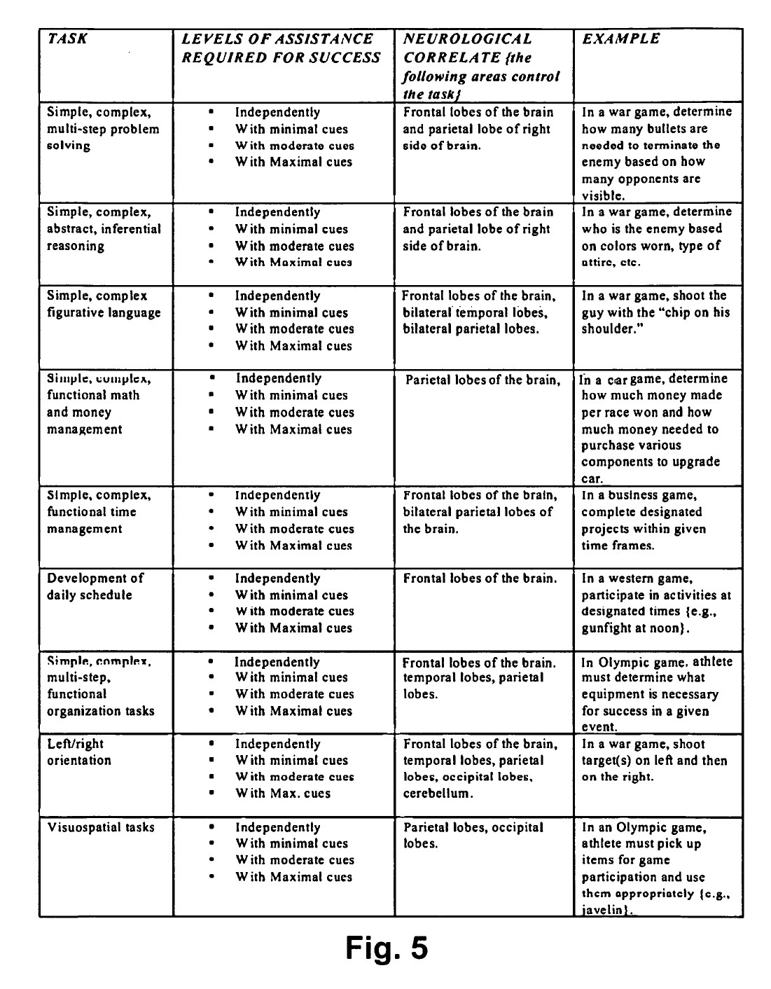

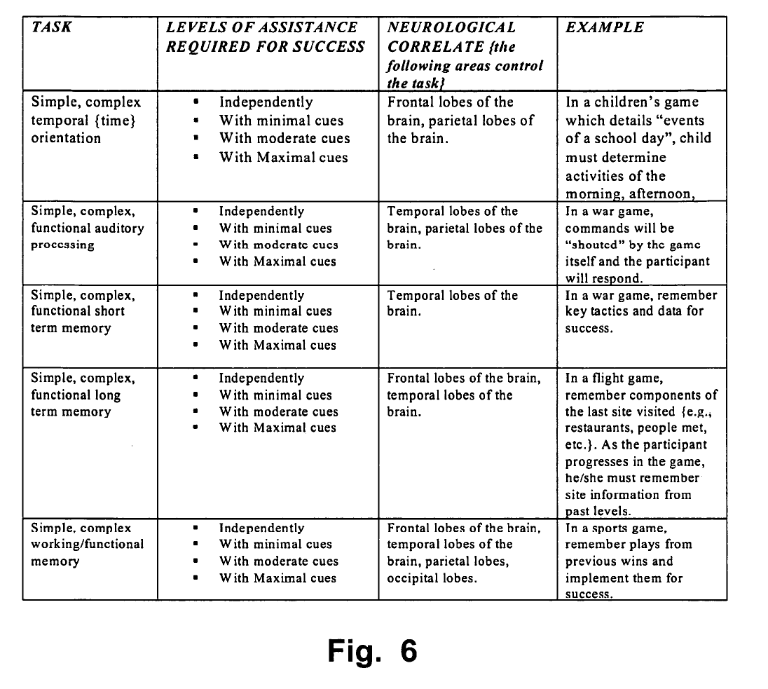

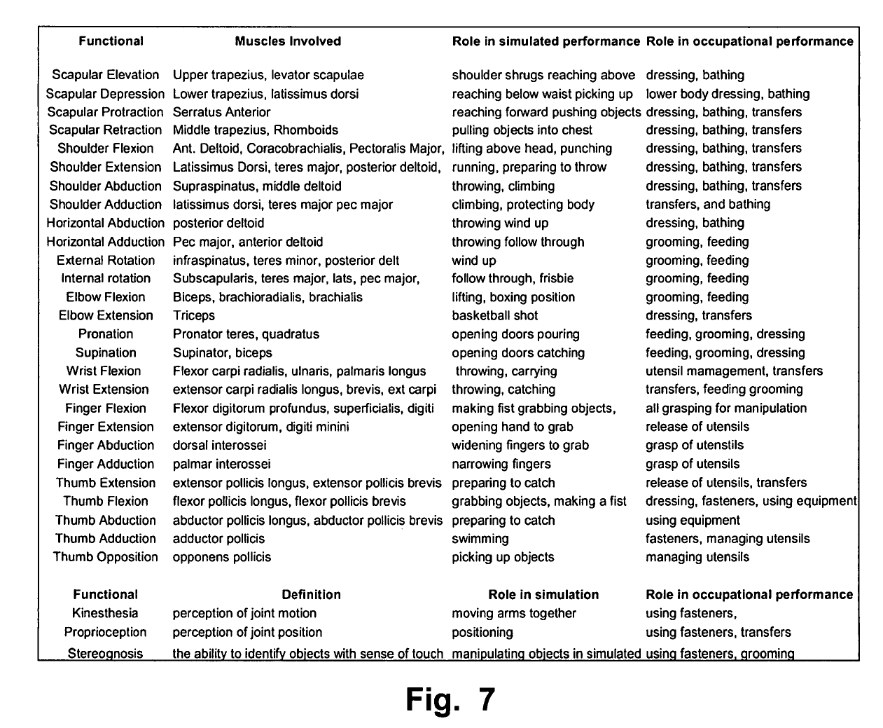

Referring now to the drawings, FIGS. 1-7 disclose some of the preferred modes of implementation of the device 10 and method disclosed herein using body engaged sensors 11 to ascertain patient movements to direct and track patient physical and cognitive therapy and athletic training.

As shown in FIG. 1 the device 10 employs a plurality of body engaged motion tracking sensors 11 which may be monitored for movement in three-dimensions using software adapted to the task to track a patients movements manipulating a controller 12 which is operatively engaged to a computer or video game console 13 having game or entertainment software onboard.

In use, the user would be equipped with body engaged sensors 11 which might be directly engaged using adhesive backing 16, or a strap 22, or as biofeedback garments such as gloves 20 that provide a stable mount for the sensors 11.

Sensor 11 monitoring for movement can be accomplished by visual means such as a plurality of cameras 26 having tracking software to monitor sensor 11 movement in three axes. Or, the sensors may be such that they are adapted to transmit a signal of their location such as using an RFID or small transmitter to one or a plurality of receivers 30 adapted to the task such as those conventionally employed for a wireless mouse. The cameras 26 would function much the same by communicating to software adapted to watch and ascertain sensor 11 positions, to a microprocessor adapted to track sensor 11 positions in three axes.

The continuous monitoring of the plurality of body-mounted sensors 11 be it visual with cameras 26, RF with receivers 30, or other means for tracking and generating an electronic signal relational to movement, as would occur to those skilled in the art, are communicated to a microprocessor with software adapted to the task to track and ascertain movements of the body part in question and ascertain progress of the patient based on the biofeedback input from movements.

As noted, based on the ascertained progress, the game levels, intensity, situational playing, and other factors of the game being played by the user, can be adjusted to provide arm, hand, back, torso, leg, or other movements, and more or less repetitions, to continually adapt the game being played, to the patient's progress in the rehabilitation regimen.

The controller 12 while shown as a joystick, may be any game controller that will operate a game on a computer or commercial game console. Employing software in a separate engageable microprocessing unit, such as a computer or video game 13, the device 10 will use the game or goal oriented software running on the game console or computer to track and direct patient movements using the sensors 11 being monitored. For patients who have lost an ability to manipulate their body to perform a specific task related to a certain tool or instrument, the controller 12 can be that instrument or tool, for instance an electric guitar. The movements of the sensors 11 in three axes are tracked for that specific function and the game or goal oriented software will be operated by movement of the sensors 11 with the substituted control 12.

In use, the motion sensors 11 placed on the patient's body 17 directly, or using a glove 20, strap 22, or on clothing, would first be calibrated for a baseline of the patient's movements while manipulating the controller 12 in a controlled manner such as with a configuration screen generated by software of the device 10 running on the computer or game console 13 or similar means for electronic microprocessing of computer software. Preferably the configuration screen of the video display 21 will provide anatomical images of the human body, which can be selected by the user or the software, so sensors 11 therein engaged can be mapped to those specific body parts and positions. During movements directed by the calibration screen generated on the display 21 by the software, a baseline can then be obtained from movements of the tracked body sensors 11 in the three axises.

Subsequent to obtaining a baseline or just ascertaining which sensors 11 are mounted where on the body of the user, software adapted for the device 10 will monitor this individual sensor 11 movement, and thus body movement, during each session. The software will continuously track the user's movements for improvement, or a degrading of those movements be it speed, flexibility, or reaction time or other aspects of the body movements being tracked.

The software running directly on the computer or game console 13 or USB or otherwise electronically engaged electronic interface 23, may take over or adjust the game being played to direct controller 12 directed curser movement so as to measure improvement. This tracking also allows the device 10 and software interfaced with the game or goal oriented software, to adjust the displayed graphics or pictures on the video display 21 to actually coerce certain movements from the patient over time while the patient operates the controller 12. This allows the device to adjust the therapy over time to fit the patient's progress or abilities or for relapse.

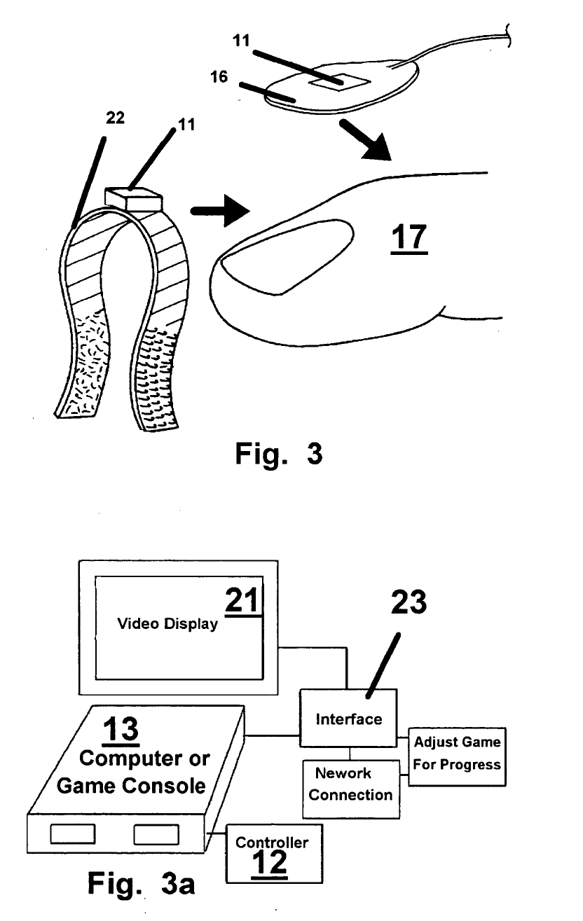

As graphically depicted in FIG. 3a a typical interconnection of the interface 23 with a computer or video game console 13 would be using a USB or other connecter and a mating of the software of the device 10 with that of the game running so as to generate game portions or routines to generate video to elicit the desired body movements. The movements would be monitored by tracking the sensors 11 and the game adjusted per the patient's progress. Those skilled in the art will realize that other means to interface the device 10 and software may be employed and such are anticipated within the scope of this application.

The device 10 using the sensors 11 and electronic means to ascertain and track sensor 11 movement in three planes or axes, may employ a microprocessor controlled interface 23 which is engaged in operative communication with cameras 26 or RF tracking receivers 30 or other means to track the patient's movements by tracking the movement of one or a plurality of the sensors 11 and to generate electronic signals employable by the software to move and run the video game running on the computer or game console 13. As a separate component interface 23 it will then be engaged to the computer or game console 13 using IR, Wifi, USB, or other means to operatively electronically connect the device 10 to the microprocessor running the software in the computer or game console 13. Or, the device 10 and its software and hardware interface may just be a separate component interface 23 having onboard software adapted to engage with a computer or game console 13, and change its performance and video presentation to run the rehabilitation program or software stored onboard using the controller 12 in a changed fashion wherein the interface 23 changes the way the controller 12 works with the game.

In a preferred method of the device 10, sensor 11 mapping would be performed in a first step, to provide baseline input regarding body movements in the areas the sensors 11 are engaged. For instance bending of fingers or hands or arm movement up and down can be mapped to the sensors using standardized movements depicted on a configuration screen of the video display 21. The user would be asked to perform certain movements with the sensors 11 properly engaged to the proper point on their body. Using the ascertained movement from tracking the sensors 11, the software would then have a baseline from which to work to track movement during the game play to track progress, and to adjust the software to elicit specific rehabilitative movements by the user.

In normal use, the device 10 will employ game, or other software adapted to direct or elicit particular desired movements by the body parts of the user to determine the individual patient's input range from sensor 11 movements. A feedback means to the patient may be provided through depiction of a progress bar on the video display 21.

Once patient movements are ascertained as trackable by using electronic means for following sensor 11 movement, the device using software adapted to the task or preprogrammed by a professional will set the range of action or motion for the patient to perform during each exercise with one or more tracked body part movements. The desired range of action or motion for the patient treatment being determined, the sensor 11 or sensors 11 involved in the manipulation of the controller 12 will be mapped, to operate a game function of the software, such as fire, move up, move down, etc. to achieve the determined motion or motions for the exercise of the patient's body.

Once the game or goal oriented software is mapped and adjusted to coerce the desired movements from the user, the game will ensue and the patients movements tracked by monitoring the movement of the individual sensors 11. The coerced body part movements may be adjusted for each session or in real time should the device 10 be engaged with a network which would allow remote professionals the change the motions coerced by the game and controller 12. This allows a real time means to monitor patient progress and provide means for adjustment of the game or video software to elicit movements ascertained to be desired for the treatment.

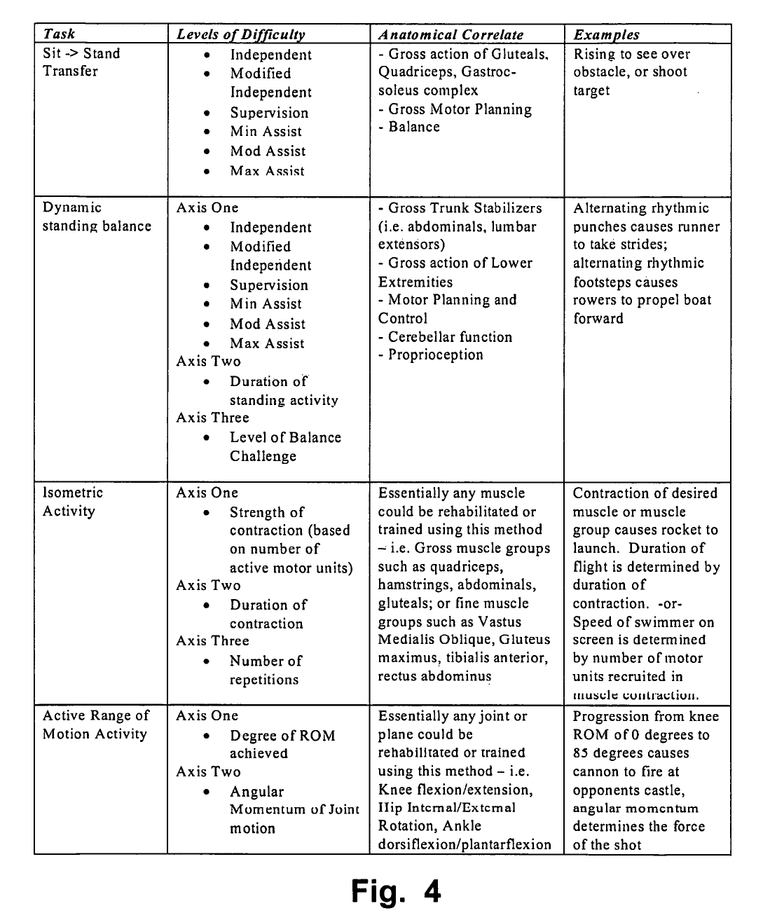

As shown in FIG. 4-7, there are numerous user motions which may be elicited using the video software and the chosen controller 12 to operate the software to provide trunk and lower extremity gross motor and balance tasks, exercises for fine movement, or exercises to enhance cognitive abilities. As shown in FIGS. 4-7, the drawing grids outline examples of the neurological area that controls a specific cognitive task and a gaming activity that could engage the target task to yield the rehabilitation required. Of course cognitive feedback software can monitor the patient's progress and allow the game to be updated to customize the patient's treatment as needed.

Also depicted in the charts of FIGS. 4-7, the device 10 and method can also be employed for occupational therapy using the game and biomechanical feedback to both ascertain what exercises to direct the patient to perform and to measure strength and range of motion during sessions and to provide data regarding patient improvement over time. The game would be adapted to exercise the noted muscles involved deemed to be such that need to be rehabilitated. The exercises can employ a role or require a simulated performance in the game of the patient in a fashion noted in the chart as a manner to exercise the muscles or body parts of the patient. The game of course can be customized according to the muscles and body portions determined in need of rehabilitation based on the noted role they play in the patient's occupational performance. Software using feedback of data from biomechanical garments and other modes of movement and strength measurement of the patient would track the patient's progress and adjust the game according to need.

All modes of the therapeutic gaming device and method herein may allow for the use of wired or wireless sensors and biomechanical feedback units to measure and facilitate upper extremity functional strength and Range of Motion (ROM). Strength and ROM could be measured as one or a plurality of data points including strength of contraction, duration of contraction, number of repetitions, degrees of ROM, and angular momentum of joint motion. Of course those skilled in the art will realize that every patient will have a customized mode of rehabilitation and the above list is not exhaustive of all potential feed back measurements and any that would occur to those so skilled are anticipated. The size and positioning of sensors 11 could be adjusted to facilitate the desired gross movement (composite finger flexion) or more of a precision fine motor movement individual finger flexion.

Although the invention has been described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and methods and modes of operation of the present invention, it is to be understood, however, that elements of different construction and configuration and other arrangements thereof, other than those illustrated and described, may be employed in accordance with the spirit of this invention. Any and all such changes, alternations and modifications as would occur to those skilled in the art are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. An apparatus for providing physical, occupational, or cognitive therapy to patients, employing video game software manipulated by a game controller and running on a central processing unit such as a computer or video game console, comprising:
means to track body movements of a user;
means to interface with said video game software running on said central processing unit;
software to track said body movements of said user in manipulations of said game controller during play of said video game, said manipulations being required to control progress of said user, on a visual display, during play of said video game;
based on said body movements of said user, said means to interface with said video game software implementing adjustments to said video game, said adjustments adapted to elicit certain said body movements by said user during said manipulations of said game controller;
said certain body movements providing a therapy to said user consisting of one or a combination of therapies, from a group of therapies including physical therapy, occupational therapy, or cognitive therapy, and
whereby said user during play of said video game, is concurrently provided a said therapy for a physical or a cognitive impairment.

2. The apparatus for providing physical, occupational, or cognitive therapy of claim 1 wherein said means to visually track body movements of a user comprises:
at least one tracking sensor engaged to an engagement point on the body of said user, said tracking sensor in said engagement point having tracking movements relative to said body movements of said user;
means to track said tracking movements of said tracking sensor and communicate an electronic signal to said interface; and
said electronic signal being relative to said tracking movements of said tracking sensor and thereby providing means to ascertain and electronically communicate said certain body movements by said user to said interface.

3. The apparatus for providing physical, occupational, or cognitive therapy of claim 2 additionally comprising:
software to track progress of said user in executing said certain body movements based on said electronic signal relative to said tracking movements; and
electronic memory in communication with said interface to store said progress of said user.

4. The apparatus for providing physical, occupational, or cognitive therapy of claim 3 additionally comprising:
based on said progress of said user, adjustment software in communication with said means to interface with said video game software, said adjustment software implementing said adjustments to said video game, to thereby elicit said certain said body movements by said user during said manipulations of said game controller during subsequent play of said game by said user.

5. The apparatus for providing physical, occupational, or cognitive therapy of claim 4 additionally comprising:
said adjustment software implementing said adjustments to said video game is a predetermined sequential implementation; and
said sequential implementation based upon said progress of said user and adapted to provide additional changes in said manipulations of said game controller based on said progress.

6. The apparatus for providing physical, occupational, or cognitive therapy of claim 2 additionally comprising:
said video game being a said video game already widely distributed and used by said users thereby providing a means to any said user for pre-instruction of said manipulations of said game controller required to play said video game.

7. The apparatus for providing physical, occupational, or cognitive therapy of claim 5 additionally comprising:
said video game being a said video game widely distributed and used by said users thereby providing a means to any said user for pre-instruction of said manipulations of said game controller required to play said video game.

8. A method for providing physical, occupational, or cognitive therapy to patients employing video game software running on a central processing unit such as a computer or game console, and employing a game controller manipulated by said patient to play said game on a video display to progress through said video game, comprising the steps of:
employing a means to visually track body movements of a patient;
employing a means to electronically interface with said video game software running on said central processing unit;
employing software to track said body movements of said patient in manipulations of said game controller during play of said video game;
implementing adjustments to said video game adapted to elicit certain said body movements by said patient during said manipulations of said game controller;
implementing said adjustments to elicit said certain body movements which provide a therapy to said patient during said play of said game;
adapting said therapy to provide one or a combination of therapies, from a group of therapies including physical therapy, occupational therapy, or cognitive therapy; and
allowing said patient to play said video game in sequential sessions and be concurrently provided said therapy.

9. The method for providing physical, occupational, or cognitive therapy to patients of claim 8 additionally comprising:
employing at least one tracking sensor engaged to an engagement point on the body of said patient which when engaged will provide tracking movements relative to said body movements of said patient; and
employing a means to track said tracking movements of said tracking sensor and to communicate an electronic signal relative to said tracking movement to said interface;
employing said electronic signal as a means to ascertain and electronically communicate said certain body movements by said patient to said interface; and
providing software in communication with said interface which employs said electronic signal of said certain body movements to implement adjustments to required play of said video game, said adjustments adapted to elicit additional said certain said body movements by said user during said manipulations of said game controller and provide a sequential treatment to said patient based on said additional said certain said body movements.

10. The method for providing physical, occupational, or cognitive therapy to patients of claim 9 additionally comprising:
employing software to track progress of said patient in executing said certain body movements based on said electronic signal relative to said tracking movements; and
employing electronic memory in communication with said interface to store said progress of said patient; and
communicating said progress over a computer network to a remote location where it can be reviewed by third parties such as medical professionals.

11. The method for providing physical, occupational, or cognitive therapy to patients of claim 10 additionally comprising:
based on said progress of said patient, remotely implementing said adjustments to said video game to thereby elicit said certain said body movements by said patient during said manipulations of said game controller.
